(19) United States
(12) Patent Application Publication
(10) Pub. No.: US 2012/0291811 A1
(43) Pub. Date: Nov. 22, 2012

(54) Feeding Tube Cleaning Devices and Methods

(76) Inventors: James H. DABNEY, Irvine, CA (US); Michael JONES, San Clemente, CA (US)

(21) Appl. No.: 13/476,447

(22) Filed: May 21, 2012

Related U.S. Application Data
(60) Provisional application No. 61/488,281, filed on May 20, 2011.

(51) Int. Cl. B08B 9/032; B08B 7/04

(52) U.S. Cl. 134/18; 134/169 C; 134/56 R

(57) ABSTRACT

A system includes a tubing set, having a pair of bladders, and a fluid drive system. When the tubing set is filled with fluid, one of the bladders is moved to generate a dynamic pressure wave in the fluid in the tubing set, while the other of the bladders is in contact with a pressure sensor which senses the pressure in the tubing set. When connected to a clogged enteric feeding tube, the system can be controlled by a control system to find the resonate frequency of the combination of the tubing set and the feeding tube, and fluid pressure waves at that frequency can be generated through the one bladder to free the clog in the feeding tube.

This application claims priority under 35 U.S.C. §119 to U.S. Provisional App. No. 61/488,281, filed 20 May 2011, entitled “Feeding Tube Cleaning Devices and Methods” by James Dabney and Michael Jones, the entirety of which is incorporated by reference herein.

### BACKGROUND

1. Field of Endeavor

The present invention relates to devices, systems, and processes useful for cleaning tubular conduits, and more specifically to feeding pumps, tube sets, catheters, and cleaning systems.

2. Brief Description of the Related Art

A large number of patients routinely require the use of enteral feeding tubes for temporary or long-term care, both to maintain their nutrition and for the administration of medication. These patients utilize an enteral feeding formula to provide their nutritional requirements and will have vitamins or medications crushed and mixed with water to meet additional medical needs.

During routine use of feeding pumps and feeding tubes, the formula, which is commonly a non-Newtonian fluid and flows under shear conditions, will occasionally set, and clog the feeding tube if the feeding tube is not immediately flushed after use. The crushed medications and vitamins tend to form clumps and contribute to this clogging. Once the tube is plugged, a nurse, typically, will attempt to clear the catheter by irrigating or forcing fluid through the catheter. Extreme care must be taken, however, as the typical feeding tube is made of soft rubber, which can easily distend (aneurysm) and rupture if excessive pressure is applied with, e.g., a syringe. If the contents enter the peritoneal cavity after a rupture of the catheter/feeding tube, serious complications can follow. Additionally, since most hospital patients on feeding tubes are post-surgical, and the tube is usually newly placed, replacement of the tube is a surgical procedure. If the nurse, or often several nurses in turn, are unable to clear the feeding tube, the patient is sent to radiology for attempted clearance under fluoroscopic control with a guide wire traversing the inner lumen of the feeding tube to clean and disrupt the gelled contents. This procedure typically works but requires additional time and a substantial cost burden to the healthcare system. If the radiologist can't clear the blockage, a surgeon has to be scheduled to replace the catheter.

### SUMMARY

One of numerous aspects of the present invention includes a system for clearing an obstruction in a conduit, the system comprising a tubing set including a proximal end, an open distal end, an inner lumen extending between the proximal and distal ends, at least two bladders spaced apart between the proximal and distal ends and in fluid communication with the inner lumen, and a fluid connector between the proximal and distal ends, a pressure transducer configured and arranged to be placed in a pressure sensing position with an exterior surface of a first of the at least two bladders, a dynamic fluid pressure generator configured and arranged to be placed in contact with an exterior surface of a second of the at least two bladders, a static fluid pressure generator attached to the tubing set fluid connector and in fluid communication with the inner lumen, wherein, when the tubing set is filled with a liquid and the open distal end is attached to said conduit, the static fluid pressure generator can raise the static fluid pressure in the conduit to a target level, the dynamic fluid pressure generator can dynamically change the fluid pressure in the inner lumen and the conduit about the static fluid target pressure through the second of the at least two bladders, and the pressure transducer can measure the pressure of the fluid in the inner lumen through the first of the at least two bladders.

In another aspect, a method for clearing an obstruction from an interior lumen of a conduit comprises determining a resonant frequency of a fluid column in the conduit interior lumen, applying a static fluid pressure to the fluid column, and applying a dynamic fluid pressure to the fluid column at the resonant frequency about the static fluid pressure until the obstruction is cleared.

Still other aspects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

The invention of the present application will now be described in more detail with reference to exemplary embodiments of the apparatus and method, given only by way of example, and with reference to the accompanying drawings, in which:

FIG. 1 illustrates a system block diagram of a system embodying principles of the present invention;

FIG. 2 illustrates a flow chart of an exemplary process;

FIGS. 3-7 illustrate several views of a first exemplary embodiment of a device of the present invention; and

FIGS. 8-10 illustrate several views of a tubing set embodying principles of the present invention.

### DETAILED DESCRIPTION OF EXEMPLARY EMBODIMENTS

Referring to the drawing figures, like reference numerals designate identical or corresponding elements throughout the several figures.

In general terms, one aspect of the present invention relates to a system that allows a person, e.g., a physician or nurse or other attendant, to clear a feeding tube that has become clogged due to feeding formula or medications congealing within the feeding tube.

Exemplary systems work by generating a resonant pressure wave at a near constant volume of fluid within a tubing set, which is coupled to the clogged feeding tube to create shear forces on the formula and re-fluidize it. Since the implanted catheter is made of a compliant material, such as soft rubber, the pressure wave also produces distension of the catheter that travels with the wave motion, mechanically separating the wall of the catheter from the clog and allowing the clog to co-mingle and mix with the working fluid. Both mechanisms also help to dissolve or re-suspend any solid medications and vitamins.

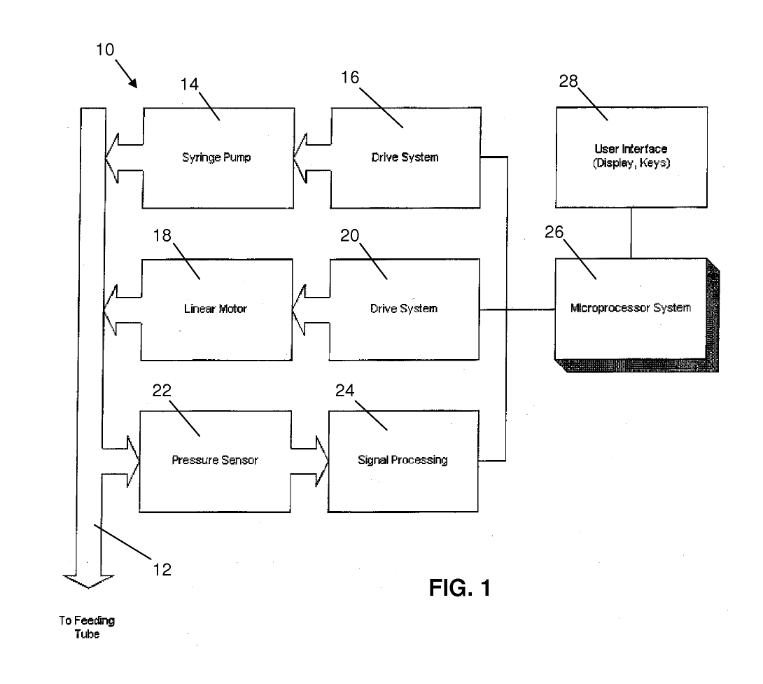

In an exemplary embodiment 10, schematically illustrated in FIG. 1, a linear motor 18 driven by a drive system 16 is used to cyclically press on a bladder (see FIGS. 9, 10) to create the pressure wave within the system. The amplitude of the pressure wave is monitored using a pressure transducer 22 and appropriate circuitry. The resulting input from monitoring the pressure wave is used by the control system formed by the software and hardware, which adjusts the frequency and linear motor amplitude to maintain the most efficient transmission of the pressure wave to the blockage. Operating parameters, such as frequency and amplitude of the pressure wave, can be periodically monitored and adjusted by the hardware under control of the software algorithm that manages the system.

Various configurations of tubing set are possible. One configuration would include the tubing set, which is formed of a length of tubing with a fluid coupling for connection to the implanted feeding tube at the proximal (extracorporeal) end of the feeding tube and a distal end of the tubing set. In the mid-section of the tubing set, two bladders are provided which are separated by a length of tubing. The distalmost of the two bladders is for sensing pressure within the tubing set and the other (proximal) bladder is for generating the pressure within the tubing set and the feeding tube. The proximal end of the pressure generating tubing set includes a connector for connecting with a (typically single-use) syringe. In this configuration, the tubing set would be pre-filled with the working fluid, e.g., water, saline, or the like.

Alternative configurations are possible, as is dry shipment of the tubing set, in which case the operator would first inject a working fluid, e.g., water into the tubing set prior to installation into the pump system. Evacuation of air dissolved in the water within the tube set is critical for optimum performance of the system, to reduce the compressability of the working fluid.

With specific reference to FIG. 1, the exemplary system 10 includes a tubular conduit 12 which is attached to the feeding tube, as described above. A syringe pump 14, driven by a drive system 16, is connected to the conduit 12 so that a working liquid can be supplied to the conduit. A linear motor 18, also driven by a drive system 20, is positioned in contact with the conduit 12 to provide dynamic pressure pulses to the fluid inside the conduit. A pressure sensor 22, with optional signal 24 processing hardware, software, or both, detects the pressure of the liquid inside the conduit 12. A data processing and control system, in this example a microprocessor system 26, is in data and control communication with the drive systems 16, 20, and the pressure sensor 22 (optionally, the signal processing 24), to receive data from the sensor 22 and provide control signals to the drive systems so that the system functions as described herein. A user interface 28, e.g., displays, input devices, keys, etc., is optionally provided so that a user can modify parameters of the system 26. As well appreciated by those of ordinary skill in the art, in systems described herein in which some or all of the system 26 is embodied in software, e.g., a set of logical instructions contained in a memory device which can be read and executed by a computing device, the system 26 includes processors, memories, input/output devices, and associated devices which permit the system to read and execute those instructions, output control signals to the drives 16, 20, and to receive and process data from the sensor 22.

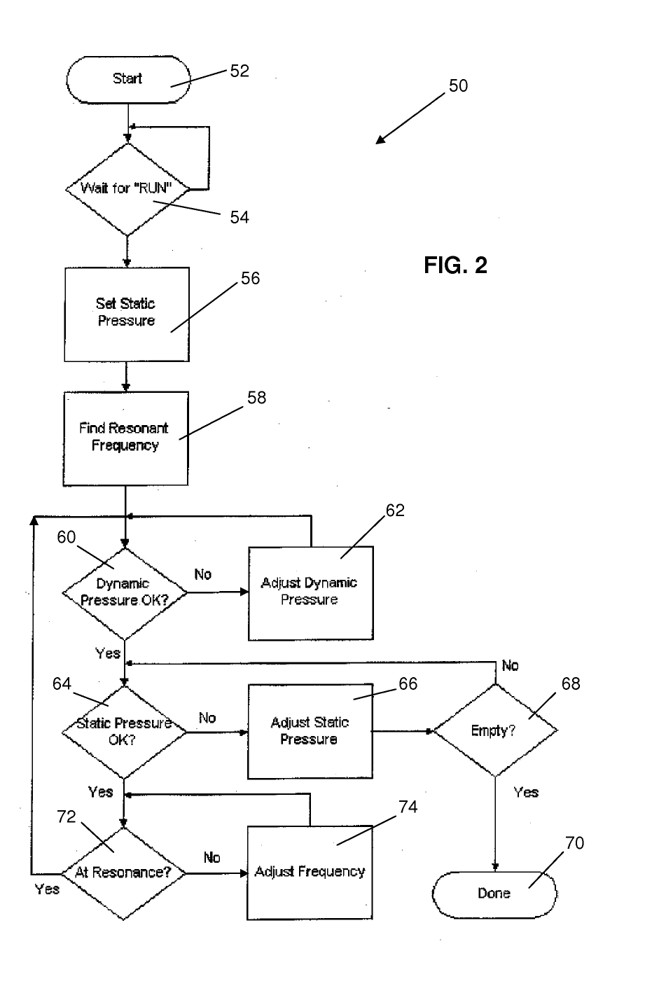

FIG. 2 illustrates an exemplary logic flow chart 50 embodying principles of the present invention. In preparation for use, the tubing set is inserted into a pump and pressure sensor assembly, the syringe is installed into the syringe pump, and the distal end of the tubing set is attached to the proximal end of the feeding tube. If the tubing set is shipped dry, the tubing set must be primed with the working fluid before this installation. At this point, operation of the system can be automated, as follows:

Upon activation by the operator 52, 54 (e.g., pressing a “RUN” key), the system will begin to monitor static pressure 56 in the tubing set via the pressure sensor 22. Under control of the system, the syringe pump 14 will cause the syringe to inject fluid into the tubing set 12 until a target static pressure is reached, which will typically be in the range of 1 psi (about 7 kPa) to 7 psi (about 49 kPa).

Next, the system will search 58 for the input frequency of the pressure wave propagating through the working fluid at which the tubing set/feeding tube assembly achieves resonance, the pressure wave being generated by the, e.g., linear motor cyclically pressing against one of the bladders of the tubing set. This may be accomplished by numerous methods. According to a first exemplary embodiment, the system will set the drive amplitude of the linear motor to a low level, and then begin to increase the operating frequency from a lowest value (typically in the area of 2 Hz) to a maximum frequency, typically in the area of 50 Hz. To achieve the scan in a reasonable period of time, the initial frequency increments may be rather large, e.g., 0.5 to 1.0 Hz per step. The resulting dynamic pressure is read for each frequency by the pressure sensor or transducer 22 through the other bladder of the tubing set 12, and the frequency at which the greatest dynamic pressure is achieved for the fixed drive level is recorded by the system. Either direction of sweep (up or down) can be used, and a sequence of contiguous or discontinuous frequencies can be used in the sweep.

A second frequency sweep, over a reduced range centered about the detected peak may be performed if desired, using much smaller increments of frequency. For instance, a 2 Hz wide band could be swept at 0.1 Hz per step, to allow more precise acquisition of the most efficient operating frequency from which to begin.

The system next sets the initial operating frequency to that determined by the preceding test, and then adjusts the (linear motor drive) amplitude to achieve the desired dynamic pressure.

Static and dynamic pressure is next monitored 60 at a sampling rate of from about 1 to 4 times per second, while the system continues to drive the syringe pump and linear motor using the parameters as determined above. If a drop of either static or dynamic pressure is detected, the system (e.g., software) will either inject additional fluid into the system using the syringe pump (64, 66), adjust the drive amplitude of the linear motor (60, 62), or retune the operating frequency of the linear motor (72, 74), as required to maintain optimal function.

If the system detects that it cannot maintain the desired static pressure (64), having expended the contents of the syringe, as indicated by the pressure read at the tubing set bladder, or by reaching the end of stroke of the syringe pump (68), the clog is considered cleared and the process is complete (70).

An exemplary system includes a control computer, which receives static and dynamic pressure information from a pressure transducer and associated circuitry. Static pressure is that pressure which is present when the voice-coil actuator (linear motor) is at rest, while dynamic pressure is that portion of the pressure in the system which is additive to the static pressure while the voice-coil actuator is active. Both pressure constituents may be extracted from a raw signal by a number of methods, such as by digital filtration and analysis in software, or by the use of discreet circuit blocks to achieve the desired performance. A preferred embodiment of a system utilizes discreet circuitry in combination with software.

Regulation of static pressure is achieved by a positive displacement pump, in the above exemplary embodiment a syringe pump that is driven by a stepper motor. Working fluid is added or removed from the tubing set as required to maintain the desired pressure.

The system's dynamic pressure is regulated by increasing or decreasing the drive level (voltage or amperage) to the linear motor (voice coil), which has a corresponding proportional effect on the force that it applies to the bladder. The linear actuator is driven with a sinusoid, the frequency of which can also be determined by software. Alternatively, sinusoidal drive can also be generated by driving a piston with a crank, and therefore a rotating motor and a crank could also serve to drive the pump, with the rotational speed of the motor adjusted to control frequency of the dynamic pressure. The drive frequency has been found to be optimized between 2 and 30 Hz, and static pressures of about 2.0 psi and dynamic pressures of approximately 2.0 psi.

Other versions of systems and processes embodying principles of the present invention do not include an automated control loop, but instead rely on a human operator to manually change the static pressure and the dynamic pressure frequency, to recognize that resonance has been achieved, and then to maintain the static pressure until the clog is cleared, i.e., employ manual tuning. Such embodiments can be accomplished in a number of ways. By way of non-limiting example, an oscillatory pressure wave can be generated by: a bladder and a linear motor as described elsewhere herein; a crank and piston pump; a linear peristaltic pump; a solenoid pounding on a bladder or bulb; or a rigid chamber in the tubing set with an internal piston that is driven by a magnetic field. The frequency can be controlled by a feedback system, as described, or could be tuned manually, because it is quite easy to identify resonance by simply holding the proximal end of the catheter between thumb and forefinger while tuning and feeling the largest pressure wave amplitude produced.

Pressure measurement can be indirect, as described herein (a bladder in chamber with a dry sensor), in which a sensor can be integrated into the tubing set and in direct contact with the fluid, or the pressure wave amplitude could be measured instead of pressure. This can be achieved by enclosing a small ball in a cage, within the fluid circuit, such that fluid motion causes the ball to move. The magnitude of the motion can be captured optically, or by proximity (capacitance) or magnetically via a pickup coil. Likewise, a movable vane in the fluid could provide this feedback. The pressure level could be set by design, since the force being exerted on the fluid will generally be known.

The syringe pump and drive bladder could also be combined, either into one longer bladder, or a variation on the syringe. In the former, a linear peristaltic pump could be formed of a roller, where the bladder is shaped like a toothpaste tube. The position of the roller sets the static pressure, while the motion of the roller created the dynamic pressure. In the latter, a syringe with a coaxial plunger could be designed, whereby the static pressure would be set by the overall position of the plunger. The movable seal portion of the plunger could be made in the form of a diaphragm, which could then be driven to generate the dynamic pressure.

If one is patient, a “dumb” system could be employed in which the frequency chosen is arbitrary, and eventually, although not optimized for efficiency, a clog would probably be broken up.

The amplitude of the dynamic pressure is advantageously regulated. The dynamic pressure is set to about 80-90% of the static pressure, so the system has a pressure bias so that the pressure waveform is symmetrical. For example, to have a 2 PSI peak-to-peak of dynamic pressure, the static pressure needs to be high enough that the pressure does not drop to 0-PSI above ambient, or the drive motor will become unloaded. This is inefficient, and also very noisy. The power required to drive the dynamic pressure wave is related to the pressure desired (more pressure requires more force), so there is a systemic limit based on design. Assuming that 7 PSI is an upper limit for pressurizing the catheter, then about 6 PSI would be the limit of dynamic pressure. Since the resonant frequency of the system is related to the static pressure, changing the static pressure detunes the system, so it would be undesirable to change the static pressure, unless this method was used to adjust as tuning changes are needed due to changes in the fluid from dissolving the clog.

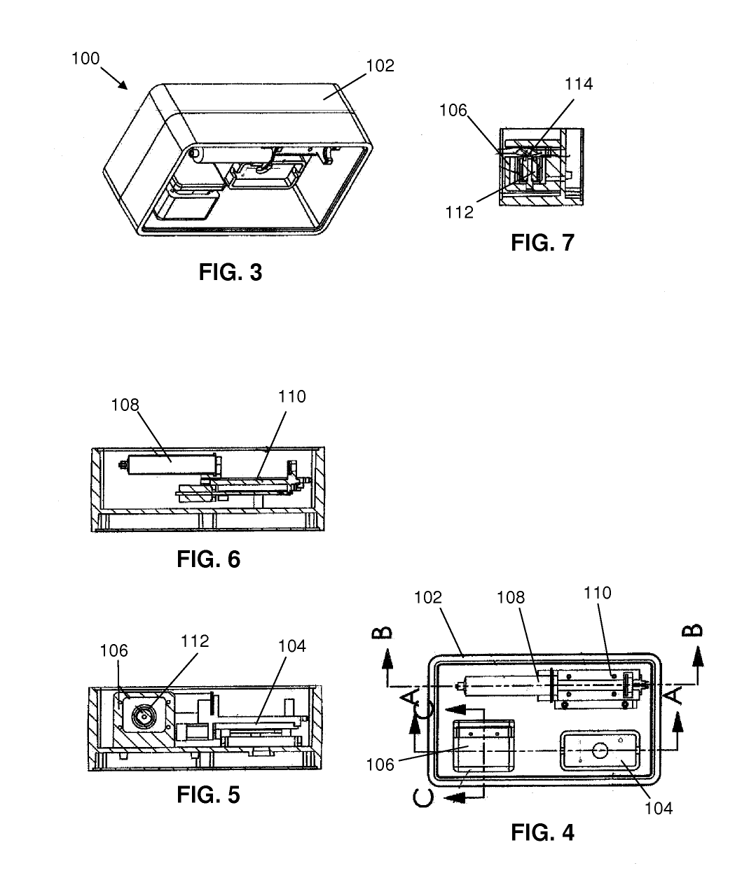

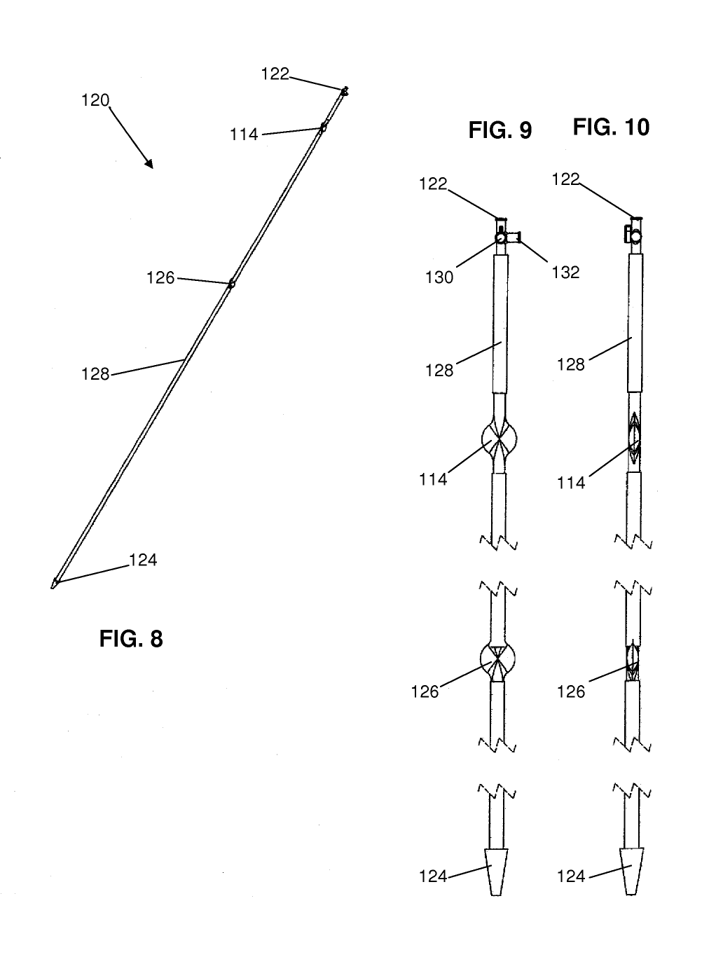

FIGS. 3-10 illustrate an exemplary system 100 and components thereof. With reference to FIGS. 3-7: FIG. 5 is a cross-sectional view taken at line A-A; FIG. 6 is a cross-sectional view taken at line B-B; and FIG. 7 is a cross-sectional view taken at line C-C. The system 100 includes a housing 102 which contains all of the mechanical components of the system, and advantageously also houses the system 26. Openings in the housing, for passage of a portion of the conduit 12 or feeding tube, and optional power cords, are not illustrated for clarity's sake. The system 100 includes a pressure sensor 104, a pressure generator 106, a syringe 108, and a syringe pump 110 for driving the syringe 108. An exemplary voicecoil 112 is provided in the pressure generator 106. FIG. 7 illustrates an exemplary bladder 114 of an exemplary conduit 12 (or 120, see FIGS. 8-10) positioned against the voicecoil 112 of the pressure generator 106. By way of non-limiting example, as seen in FIG. 4, a conduit 12 or 120 would be positioned on the pressure sensor 104 and the pressure generator 106 and held in that position (e.g, by non-illustrated clamps or the like) so that the sensor and pressure generator can sense the fluid pressure, and generate pressure, in the conduit, respectively.

As illustrated in FIGS. 8-10, an exemplary tube set or conduit 120 utilizes tubing, two film bladders, and fittings. The tubing set at the proximal end has a valving system 122 that allows for priming and for connection to a syringe (e.g., 10 to 30 ml) driven by a controlled syringe pump, as described herein. The distal end of the tube set connects, with a fluid connector 124, directly to the proximal end of the patient's feeding tube with a fitting. Alternatively, the tubing set, bladder and syringe may be prefilled with fluid and sealed for long-term storage, easing installation and use by the care provider.

The set or conduit 120 includes an elongate tube 128 having a hollow interior (a lumen) extending its length between the proximal and distal ends. At least two bladders 114, 126, are formed in the tube 128, one for providing a dynamic pressure wave to the working liquid in the tube, and the other for sensing the pressure in the tube, as described herein. The proximal connector 122 optionally includes a stopcock or similar valve 130, and a second fluid port 132, so the conduit 128 can be flushed, primed, and air removed prior to use.

The tubing set and bladder is advantageously constructed of polyurethane or vinyl with an approximate durometer of 70 shore A. Other materials may be suitable if the right blend of material properties is achieved. More elastomeric materials will absorb substantial energy from the pressure wave, lessening delivery efficiency. More rigid materials will improve delivery efficiency but must be flexible enough to bend and make connecting to the feeding tube an easy proposition. Typically all of the connectors are formed of a rigid material such as nylon, polycarbonate, or polypropylene. Construction of the tubing set can be achieved by a mix of RF welding and adhesive bonding of the connectors and bladder to the tubing, as will be readily apparent to a person of ordinary skill in the art.

The tubing set has the bladders connected by tubes. In one exemplary embodiment, the bladders are mounted in a plastic frame and have the two frames slide and lock into position beneath the voice coil and pressure sensor. An outer door, when closed, locks the frames and the bladders in place, and holes between the case and the door allow passage of the tubing into and out of the pump housing. The only couplings are Luer fittings to allow connection of the syringe and a tapered barbed fitting for connecting the feeding tube at the distal end.

Alternate configurations for mechanically creating the pressure wave can include: a low frequency speaker within the tubing set; piezo-electric chips that are in fluid communication with, e.g., within, the fluid column of the tubing set; a reciprocating cam driven piston drive; and a fast acting syringe pump.

Mechanical Pump Components

A preferred mechanical pump has the following components:
Linear motor
Pressure transducer
Syringe pump
Electronic Boards
Chassis
Housing
Cassette Clamp

Tubing Set Components
Distal tapered connector with a feeding tube retention mechanism
Tubing (approx 4 mm ID)
Pressure sensing bladder
Pressure generating bladder
Connection tubing
Stopcock
Syringe (10 to 30 ml)

Control Electronics

The actuation and control system can include the following:
Microprocessor system supporting:
   Analog inputs (pressure monitoring system)
   Analog outputs (drive signal for voice-coil actuator)
   User interface (display, inputs, annunciator)
   Syringe pump drive
   Execution of control algorithm
   Power supply monitoring
   Signal conditioning
   Pressure transducer amplifier
   Static pressure detection (low-pass filter)
   Dynamic Pressure detection (RMS converter or active rectifier, and filters)
   Actuator drive electronics
   Power supply

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

We claim:

1. A system for clearing an obstruction in a conduit, the system comprising:
a tubing set including a proximal end, an open distal end, an inner lumen extending between the proximal and distal ends, at least two bladders spaced apart between the proximal and distal ends and in fluid communication with the inner lumen, and a fluid connector between the proximal and distal ends;
a pressure transducer configured and arranged to be placed in a pressure sensing position with an exterior surface of a first of the at least two bladders;
a dynamic fluid pressure generator configured and arranged to be placed in contact with an exterior surface of a second of the at least two bladders;
a static fluid pressure generator attached to the tubing set fluid connector and in fluid communication with the inner lumen;
wherein, when the tubing set is filled with a liquid and the open distal end is attached to said conduit, the static fluid pressure generator can raise the static fluid pressure in the conduit to a target level, the dynamic fluid pressure generator can dynamically change the fluid pressure in the inner lumen and the conduit about the static fluid target pressure through the second of the at least two bladders, and the pressure transducer can measure the pressure of the fluid in the inner lumen through the first of the at least two bladders.

2. A system according to claim 1, further comprising
a control system in signal communication with the pressure transducer, the dynamic fluid pressure generator, and the static fluid pressure generator, the control system being configured and arranged to receive a signal from the pressure transducer indicative of the fluid pressure in the inner lumen, and to control the static fluid pressure generator to maintain the static pressure in the inner lumen at the target pressure, and to control the dynamic fluid pressure generator to dynamically change the fluid pressure in the inner lumen about the static fluid target pressure.

3. A system according to claim 1, wherein:
the static fluid pressure generator comprises a syringe and a syringe actuator in control communication with the control system.

4. A system according to claim 1, wherein the dynamic fluid pressure generator comprises an oscillatory fluid pressure generator.

5. A system according to claim 1, wherein the dynamic fluid pressure generator comprises a device selected from the group consisting of voicecoil linear motor, a low frequency speaker, a piezo-electric chip, a reciprocating cam driven piston, and a fast acting syringe pump.

6. A system according to claim 1, further comprising:
a housing having an interior space;
wherein the static fluid pressure generator, the dynamic fluid pressure generator, and the pressure transducer are positioned inside the housing interior space; and
wherein the tubing set is positioned partially in the housing interior space with the open distal end extending out of the housing, with the pressure transducer in contact with the exterior surface of the first of the at least two bladders, and with the dynamic fluid pressure generator in contact with the exterior surface of the second of the at least two bladders.

7. A system according to claim 1, further in combination with said conduit, the conduit being a clogged enteral feeding tube connected to the open distal end of the tubing set.

8. A method for clearing an obstruction from an interior lumen of a conduit, the method comprising:
determining a resonant frequency of a fluid column in the conduit interior lumen;
applying a static fluid pressure to the fluid column; and
applying a dynamic fluid pressure to the fluid column at the resonant frequency about the static fluid pressure until the obstruction is cleared.

9. A method according to claim 8, wherein the conduit is an enteral feeding tube.

10. A method according to claim 8, wherein determining a resonant frequency of a fluid column in the conduit interior lumen comprises:
setting an amplitude of a pressure oscillation in the fluid column;
changing an operating frequency of the pressure oscillation between a first low frequency and a second higher frequency;
reading a resulting dynamic pressure for each frequency by a pressure transducer; and
determining a frequency at which a greatest dynamic pressure is achieved for the pressure oscillation amplitude.

11. A method according to claim 8, wherein changing an operating frequency comprises increasing the operating frequency of the pressure oscillation from the first low frequency to the second higher frequency.

12. A method according to claim 8, wherein changing an operating frequency comprises decreasing the operating frequency of the pressure oscillation from the second higher frequency to the first low frequency.

13. A method according to claim 8, wherein changing an operating frequency comprises changing in a sequence of contiguous or discontinuous frequencies.

14. A method according to claim 8, after said determining, further comprising:
setting an amplitude of pressure oscillation in the fluid column;
changing the operating frequency of the pressure oscillation between a third low frequency below said frequency obtained from said determining and a fourth higher frequency above said frequency obtained from said determining;
reading a resulting dynamic pressure for each frequency by a pressure transducer; and
determining a frequency at which a greatest dynamic pressure is achieved for the pressure oscillation amplitude.

15. A method according to claim 8, wherein changing an operating frequency comprises changing the frequency in steps.

16. A method for clearing an obstruction from an interior lumen of a conduit, the method comprising:
providing a system according to claim 1;
determining a resonant frequency of a fluid column in the conduit interior lumen with said system;
applying a static fluid pressure to the fluid column with said system; and
applying a dynamic fluid pressure to the fluid column at the resonant frequency about the static fluid pressure with said system until the obstruction is cleared.
